(19) United States
(12) Patent Application Publication
(10) Pub. No.: US 2018/0161741 A1
(43) Pub. Date: Jun. 14, 2018

(54) FOOD PROCESSING MACHINE WITH LIQUID INJECTION

(71) Applicant: Vela Blend, Inc., Gilbert, AZ (US)

(72) Inventors: Matthew Sedlacek, Gilbert, AZ (US); Joseph Velasquez, Scottsdale, AZ (US); Angie Nguyen, Tempe, AZ (US); Robert Fulbright, Mesa, AZ (US)

(21) Appl. No.: 15/377,834

(22) Filed: Dec. 13, 2016

(51) Int. Cl. B01F 15/02; A47J 43/046; B01F 7/20; B01F 15/06; B01F 15/00

(52) U.S. Cl. CPC B01F 15/0203; A47J 43/046; B01F 7/20; B01F 2215/0026; B01F 15/00318; B01F 2015/062; B01F 2215/0014; B01F 15/06

(57) ABSTRACT

Food processing can include providing a reservoir for holding a liquid; and injecting the liquid from the reservoir into a container for processing a set of ingredients.

### BACKGROUND

A food processing machine can include mechanisms for rendering a food preparation from a set of ingredients. For example, a blender can include a carafe with a blending mechanism for blending a set of ingredients inside the carafe. A user of the blender can add ingredients to the carafe, pour liquid into the carafe, and then blend the ingredients inside the carafe.

### SUMMARY

In general, in one aspect, the invention relates to a food processing machine with liquid injection. The food processing machine can include: a reservoir for holding a liquid; and an injection mechanism for conveying the liquid from the reservoir into a container for processing a set of ingredients.

In general, in another aspect, the invention relates to a method for food processing. The method can include: providing a reservoir for holding a liquid; and injecting the liquid from the reservoir into a container for processing a set of ingredients.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a food processing machine in one or more embodiments.

FIG. 2 illustrates an embodiment of a food processing machine that includes a container attachment.

FIG. 3 illustrates an embodiment of a food processing machine with a reservoir that includes a heating element.

FIG. 4 illustrates an embodiment of a food processing machine that includes a reservoir for holding liquid of ambient temperature and a reservoir for holding hot liquid.

FIG. 5 illustrates a set of control mechanisms of a food processing machine in one or more embodiments.

FIG. 6 illustrates a modular arrangement of a food processing machine in one or more embodiments.

FIG. 7 is an exploded view of a module of a food processing machine that includes reservoirs and injection mechanisms in one or more embodiments.

FIG. 8 is a cut-away view of a set of modules of a food processing machine that include a drive mechanism and injection pumps and a heating element in one or more embodiments.

FIG. 9 is a cut-away view of a set of modules of a food processing machine that include a blending carafe and a drive mechanism and a reservoir in one or more embodiments.

FIG. 10 is an exploded view of a food processing machine in one or more embodiments.

FIG. 11 is a view of a set of modules of a food processing machine that include a blending carafe and a drive mechanism in one or more embodiments.

FIG. 12 shows pressure release mechanisms of a blending carafe and a blending sleeve in one or more embodiments.

FIG. 13 shows a reservoir with decorative and utilitarian components in one or more embodiments.

FIG. 14 shows how a stirring bowl couples to a drive mechanism in one or more embodiments of a food processing machine.

FIG. 15 shows a stirring mechanism of a stirring bowl in one or more embodiments.

FIG. 16 shows a heating element in one or more embodiments of a stirring attachment.

FIG. 17 shows a release button of a container attachment in one or more embodiments.

FIG. 18 illustrates a method for food processing in one or more embodiments.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

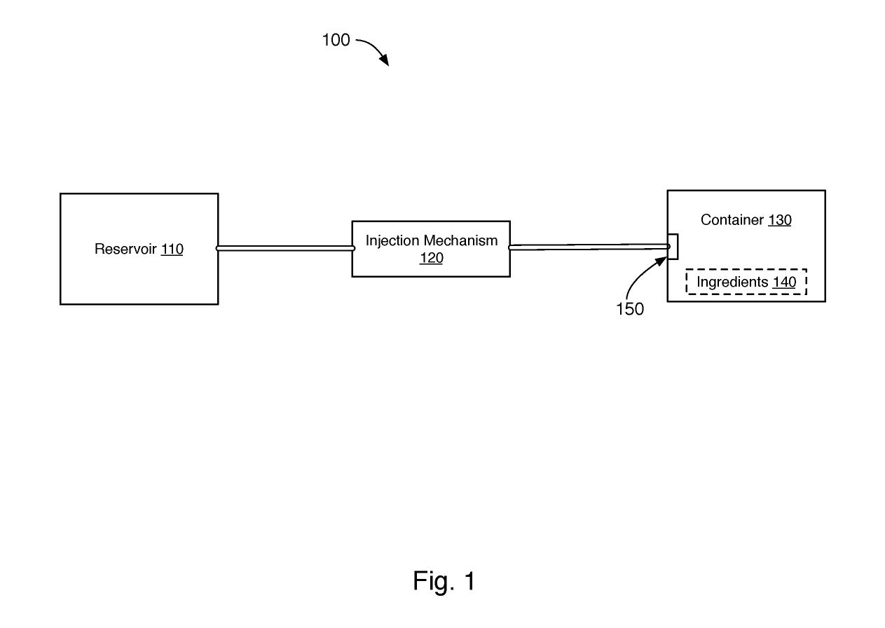

FIG. 1 illustrates a food processing machine 100 in one or more embodiments. The food processing machine 100 includes a reservoir 110 for holding a liquid, e.g., water, for use in a processing of a set of ingredients 140 inside a container 130. The food processing machine 100 includes an injection mechanism 120 for conveying the liquid from the reservoir 110 into the container 130.

In one or more embodiments, the ingredients 140 can be freeze-dried ingredients for a soup, a smoothie, a nutritional supplement, etc., to name a few examples. The ingredients 140 can be prepackaged inside the container 130. The ingredients 140 can be added to the container 130 by a user of the food processing machine 100. The ingredients 140 can be a combination of prepackaged ingredients and ingredients added by a user.

The reservoir 110 can hold a “cold” liquid, e.g., liquid at an ambient temperature. The reservoir 110 can hold a hot liquid. In one or more embodiments, the hot liquid, e.g., hot water, can be used for blending soups, thawing and blending frozen ingredients, etc.

The injection mechanism 120 can include an electric pump for conveying liquid from the reservoir 110 into the container 130. The container 130 can include an injection port 150 that enables liquid to enter the container 130. For example, the injection port 150 can include a valve or other opening that enables liquid arriving under pressure at the injection port 150 to enter the container 130.

In some embodiments, the injection mechanism 120 can inject liquid into the container 130 through an open top of the container 130.

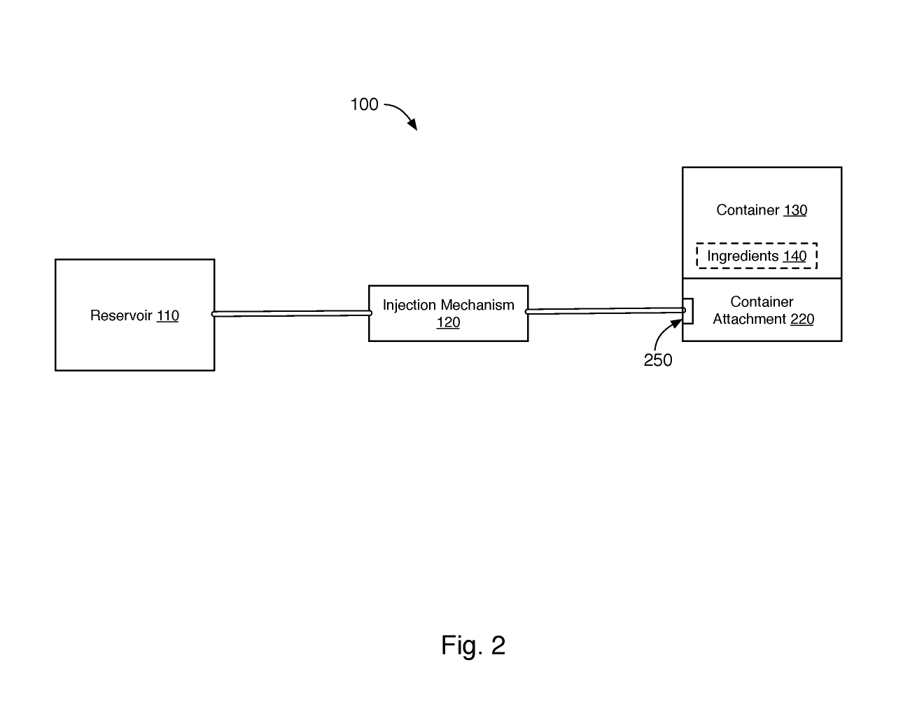

FIG. 2 illustrates an embodiment of the food processing machine 100 that includes a container attachment 220. The container attachment 220 couples to the container 130. The container attachment 220 includes an injection port 250 that enables the liquid from the reservoir 110 to enter the container 130. For example, the injection port 250 can be a valve that opens under pressure from the injection mechanism 120.

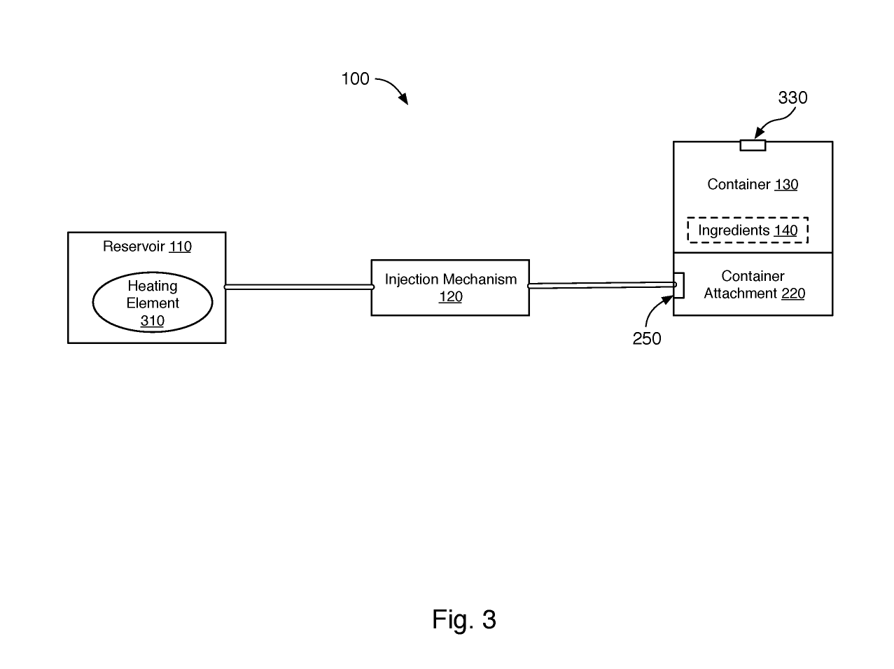

FIG. 3 illustrates an embodiment of the food processing machine 100 in which the reservoir 110 includes a heating element 310. The heating element 310 provides a hot liquid that can be injected into the container 130 by the injection mechanism 120. The heating element 310 can be a heating coil, an instantaneous line heating device, etc.

In one or more embodiments, the container 130 includes a pressure release mechanism 330. The pressure release mechanism 330 can prevent high pressure buildup inside the container 130 by releasing an amount of air from the container 130 equivalent to an amount of liquid injected into the container 130. The pressure release mechanism 330 can be a valve that opens when the pressure inside the container 130 exceeds a predetermined amount of pressure. The pressure release mechanism 330 can vent steam buildup from inside the container 130. In some embodiments, the container attachment 220 can include the pressure release mechanism 330.

In some embodiments, the container attachment 220 can include a manual pressure release mechanism for releasing pressure from inside the container 130 when a user actuates the manual pressure release mechanism, e.g., by pressing a button of the container attachment 220. A manual pressure release mechanism can be integrated with a mechanism that enables a user to release the container attachment 220 from the container 130.

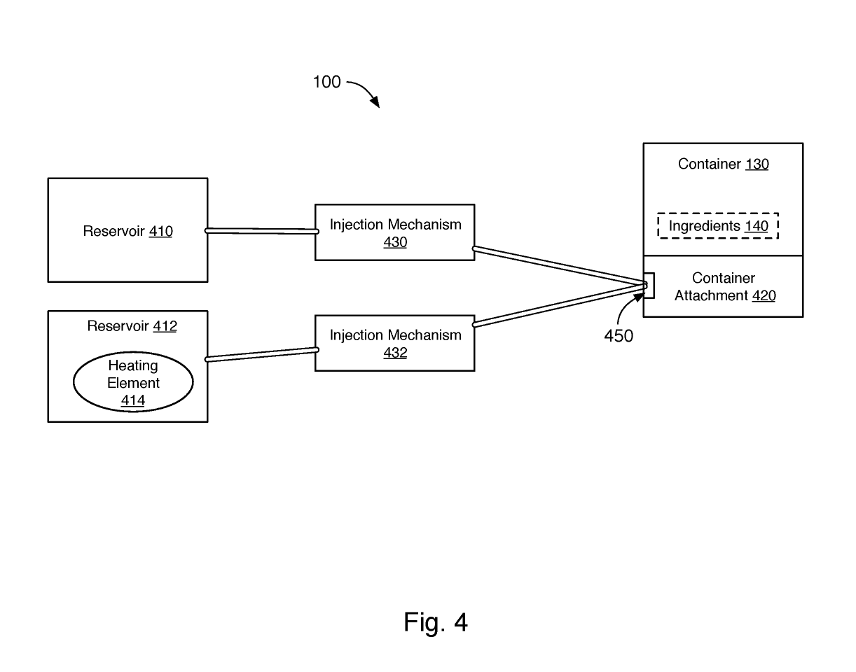

FIG. 4 illustrates an embodiment of the food processing machine 100 that includes a reservoir 410 for holding a liquid of ambient temperature and a reservoir 412 for holding a liquid heated by a heating element 414. In this embodiment, the food processing machine 100 includes an injection mechanism 430 for conveying the liquid from the reservoir 410 into the container 130 and an injection mechanism 432 for conveying the liquid from the reservoir 412 into the container 130.

The food processing machine 100 in this embodiment includes a container attachment 420 that couples to the container 130. The container attachment 420 includes an injection port 450 that enables liquid from the reservoirs 410-412 to be injected into the container 130.

In some embodiments, the injection mechanisms 430-432 can inject liquid directly into the container 130, e.g., through an open top of the container 130.

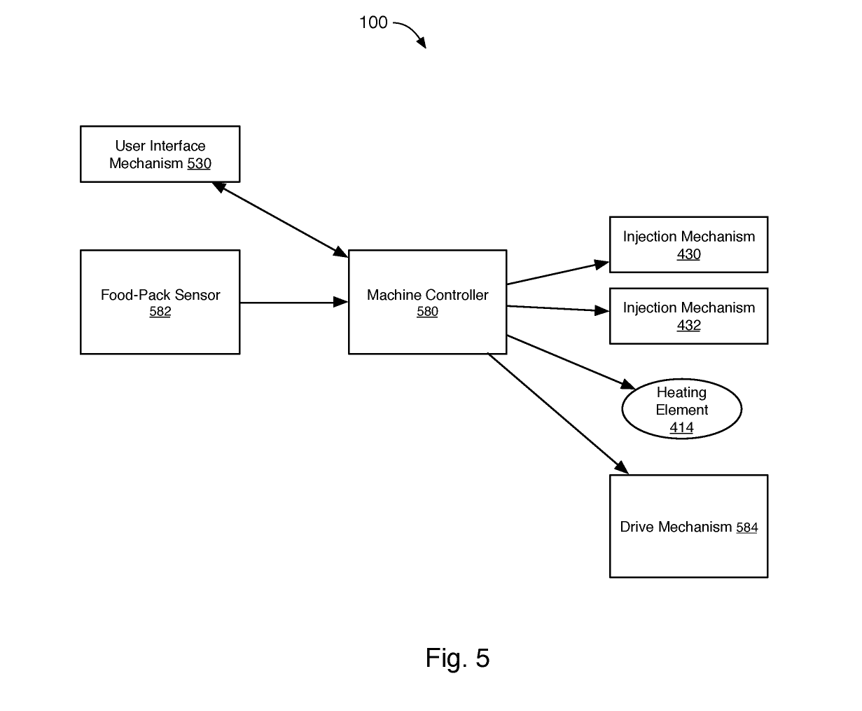

FIG. 5 illustrates a set of control mechanisms of the food processing machine 100 in one or more embodiments. The food processing machine 100 includes a machine controller 580 for controlling the functions of the injection mechanisms 430-432 and the heating element 414. The machine controller 580 also controls the functions of a drive mechanism 584. For example, the drive mechanism 584 can be a motor for turning blending blades, stirring blades, stirring mechanisms, etc.

The machine controller 580 can activate the heating element 414, the injection mechanisms 430-432, and the drive mechanism 584 at the appropriate times with the appropriate control settings to process the ingredients 140 inside the container 130. For example, the machine controller 580 can activate the heating element 414 when processing of the ingredients 140 requires heated liquid, and apply the appropriate control settings for liquid temperature, etc. In another example, the machine controller 580 can activate the injection mechanism 430 or the injection mechanism 432, or both, at the appropriate times or intervals to inject hot or cold liquid or a combination of hot and cold liquid into the container 130. In yet another example, the machine controller 580 can activate the drive mechanism 584 at the appropriate times or intervals and speeds to process the ingredients 140 inside the container 130. In yet another example, the machine controller 580 can perform a maintenance cycle in which vinegar from one of the reservoirs is pumped through the system. A cleaning cycle can be adapted to what kind of liquid has been used to process the ingredients 140, e.g., milk, coconut milk, etc.

In some embodiments, the machine controller 580 can maintain preheated liquid in a small reservoir for quickly thawing the ingredients 140.

In one or more embodiments, the food processing machine 100 includes a food-pack sensor 582 that scans a food-pack code from a food-pack that contains the ingredients 140. For example, the food-pack sensor 582 can include a scanning mechanism for scanning a bar code, QR code, etc., from a food-pack that contains the ingredients 140. In one or more embodiments, the ingredients 140 are prepackaged inside the container 130 and the food-pack sensor 582 reads a food-pack code from a surface of the container 130.

The machine controller 580 can activate the heating element 414, the injection mechanisms 430-432, and the drive mechanism 584 in response to the food-pack code read from the container 130. For example, the timing parameters and settings for the heating element 414, the injection mechanisms 430-432, and the drive mechanism 584 for processing the ingredients 140 inside the container 130 can be encoded in a food-pack code.

In one or more embodiments, the food processing machine 100 includes a user interface mechanism 530, e.g., a touchscreen, that enables a user to provide inputs to the machine controller 580. A user can enter their preferences pertaining to the processing of the ingredients 140 via the user interface mechanism 530. The machine controller 580 can adjust the processing parameters for the heating element 414, the injection mechanisms 430-432, and the drive mechanism 584 accordingly. For example, if a user specifies a preference for thicker soup preparations, the machine controller 580 can adjust the liquid heating and injection parameters accordingly to yield a thicker soup from the ingredients 140.

In one or more embodiments, the container 130 is a blending carafe. In one or more other embodiments, the container 130 is a disposable blending sleeve that slips into a blending carafe. In still other embodiments, the container 130 is a stirring bowl.

In one or more embodiments, the food processing machine 100 includes a mechanism, e.g., a flow meter, flow gauge, etc., for measuring a volume of liquid injected into the container 130. A mechanism for measuring a volume of liquid can measure a volume of liquid at ambient temperature or a volume of heated liquid, or both.

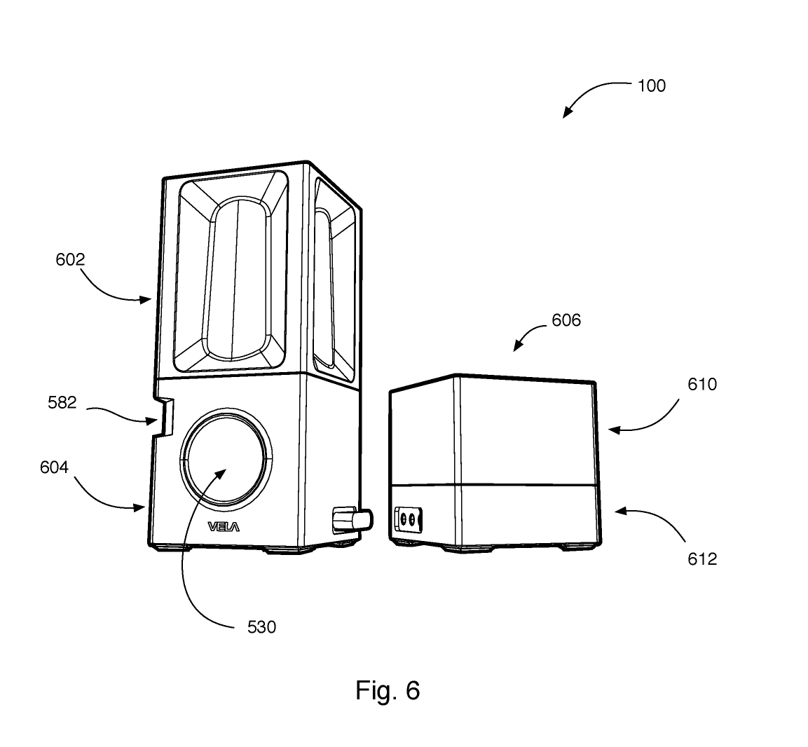

FIG. 6 illustrates a modular arrangement of the food processing machine 100 in one or more embodiments. The modular arrangement of the food processing machine 100 includes a set of modules 602-606. The module 602 houses a blending carafe with or without a blending sleeve. The module 604 includes the drive mechanism 584, the user interface mechanism 530, in this example a touchscreen, and the food-pack sensor 582.

The module 606 includes an upper portion 610 that houses the reservoir 410. The module 606 includes a lower portion 612 that houses the reservoir 412 with the heating element 414. The module 606 also houses the injection mechanisms 430-432.

In one or more embodiments, the modules 602 and 604 can function without the module 606 which can be added as an option. For example, a user can add liquid manually into the container 130.

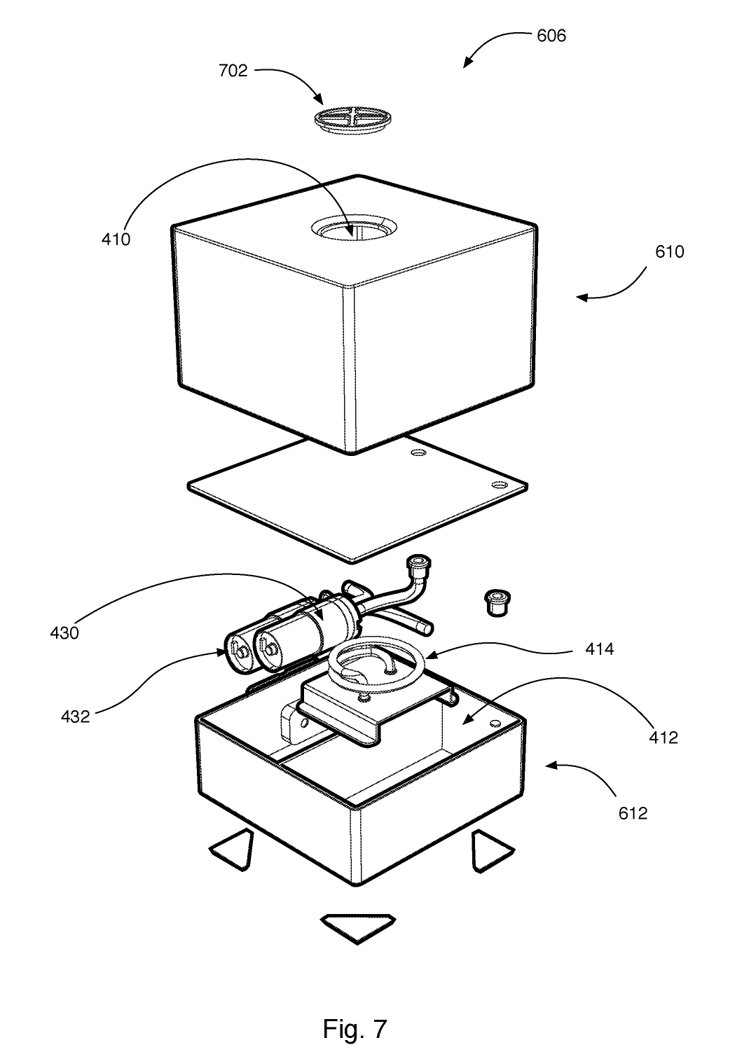

FIG. 7 is an exploded view of the module 606 in one or more embodiments. The module 606 includes a removable cap 702 that enables a user to refill the reservoir 410 housed in the upper portion 610 of the module 606. For example, a user can carry the module 606 to a liquid dispenser and fill the reservoir 410 through the opening left by the cap 702. The module 606 in some embodiments can include a handle for facilitating carrying. The upper portion 610 can be detached from the lower portion 612 and carried to a liquid source.

The lower portion 612 contains the reservoir 412 with the heating element 414. The lower portion 612 contains the injection mechanisms 430-432 which are respective pumps for the cold liquid from the reservoir 410 and the hot liquid from the reservoir 412.

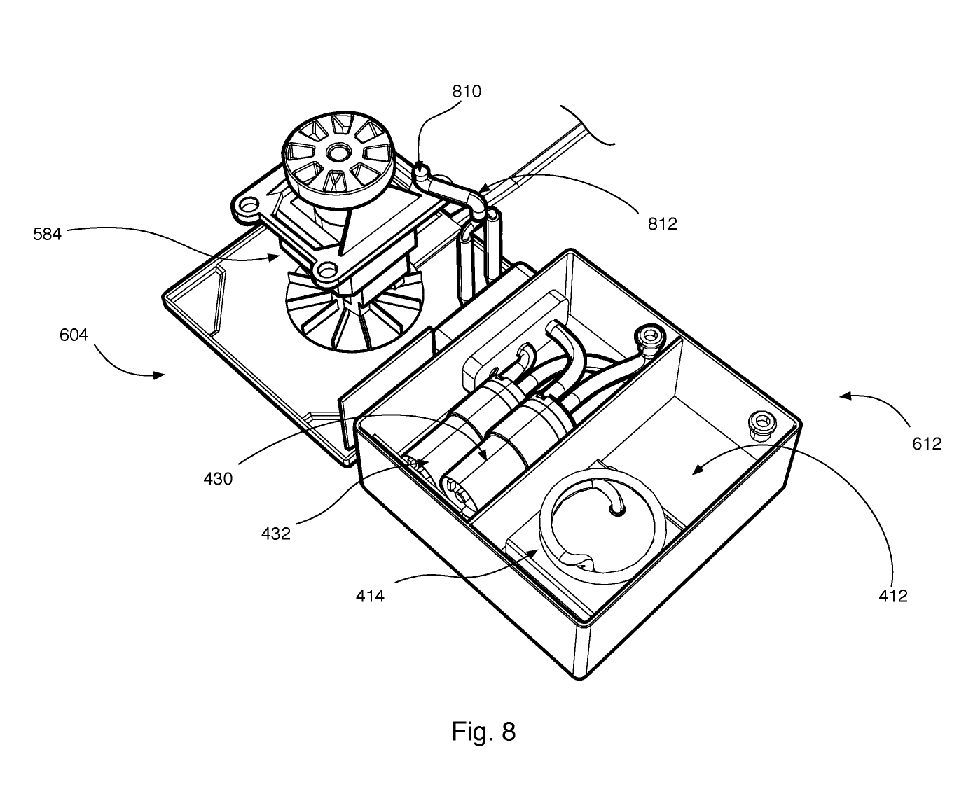

FIG. 8 is a cut-away view of the lower portion 612 of the module 606 alongside a cut-away view of the module 604 in one or more embodiments. The module 604 contains the drive mechanism 584, e.g., an electric motor. Also shown is an opening 810 of a conduit 812 that carries liquid from the reservoirs 410-412 via the injection mechanisms 430-432.

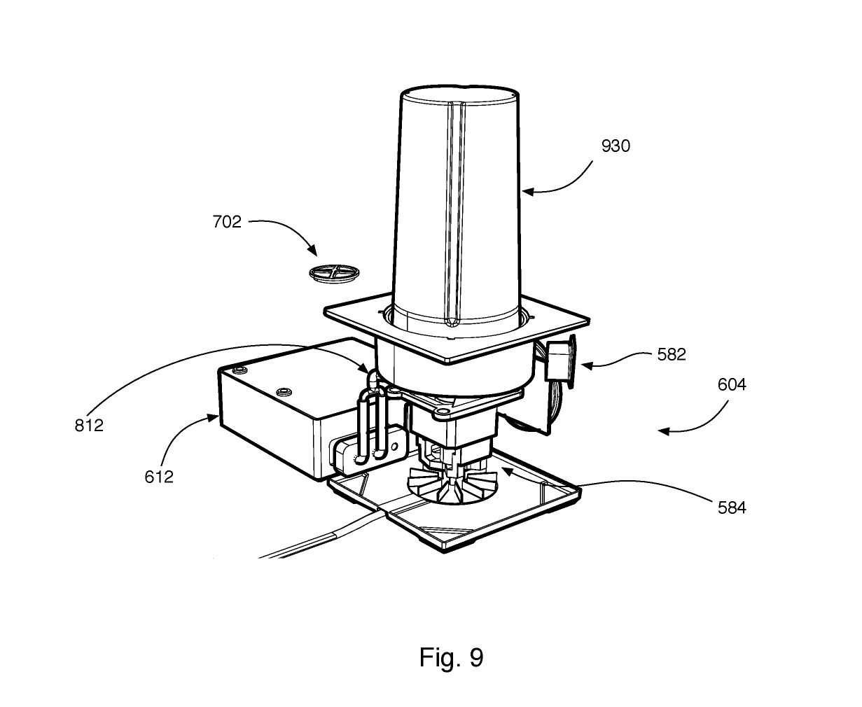

FIG. 9 is a cut-away view showing a blending carafe 930 inside the module 604 in one or more embodiments. The blending carafe 930 in one or more embodiments couples upside-down to the drive mechanism 584 via the container attachment 420 (not shown in FIG. 9). The conduit 812 injects liquid from the reservoirs 410-412 into the blending carafe 930 through the injection port 450 of the container attachment 420.

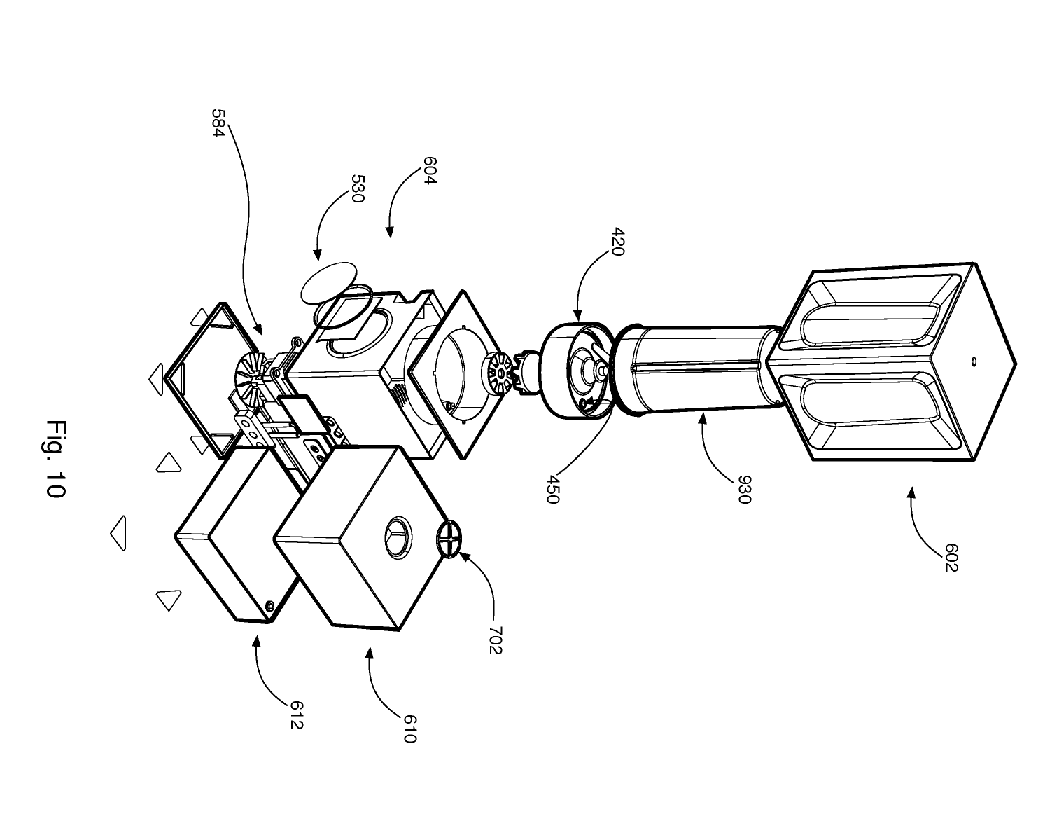

FIG. 10 is an exploded view of the food processing machine 100 in one or more embodiments. The blending carafe 930 fits inside the module 602 and the container attachment 420 couples the blending carafe 930 to the drive mechanism 584 of the module 604. Also shown is the injection port 450 of the container attachment 420 that enables the supplies of liquid from the reservoirs 410-412 to enter the blending carafe 930.

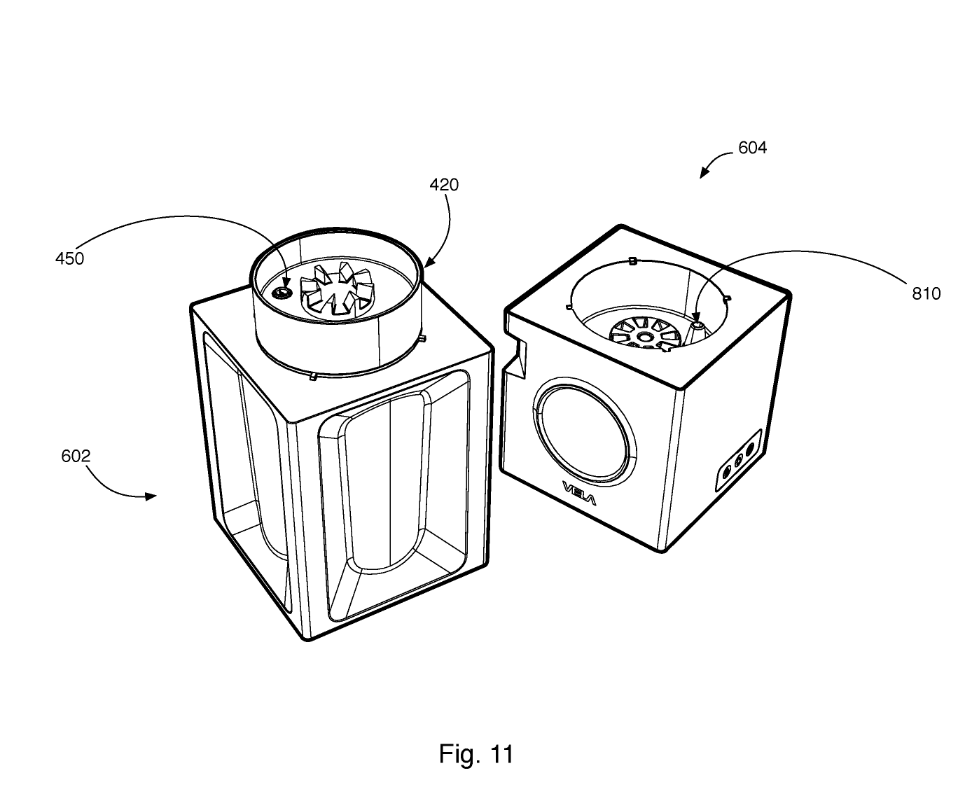

FIG. 11 is a view showing how the module 602 containing the blending carafe 930 couples to the drive mechanism 584 of the module 604. The opening 810 of the conduit 812 provides liquid from the reservoirs 410-412 to the injection port 450 of the container attachment 420.

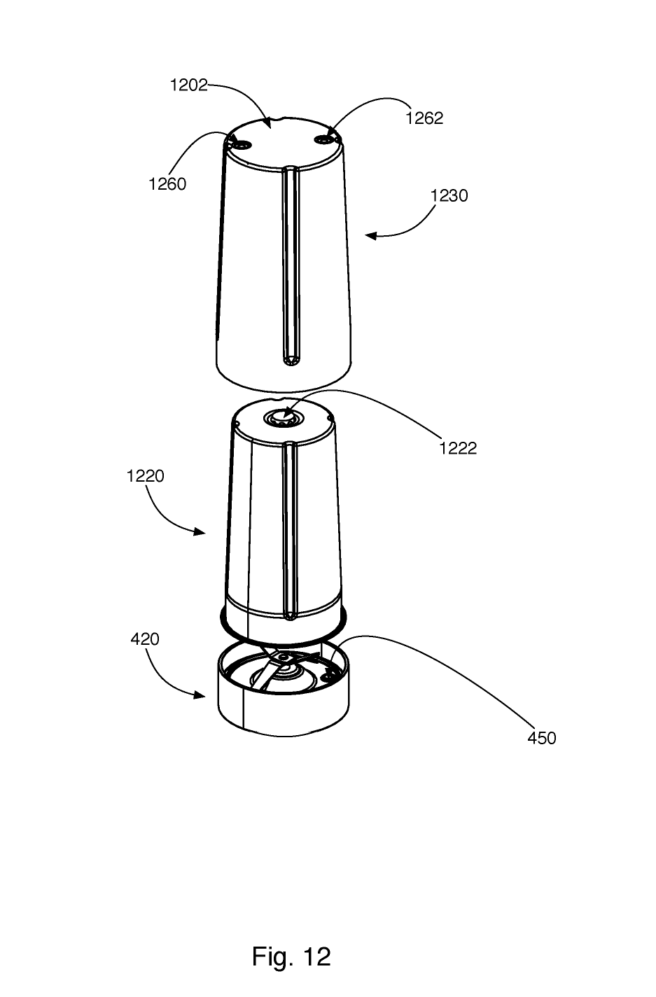

FIG. 12 shows a pair of pressure release valves 1260-1262 in a bottom side 1202 of a blending carafe 1230. The pressure release valves 1260-1262 prevent excessive pressure buildup inside the blending carafe 1230 when hot liquid is injected into the blending carafe 1230 via the injection port 450 of the container attachment 420 and the ingredients 140 are processed inside the blending carafe 1230.

Also shown is a blending sleeve 1220 that slips inside the blending carafe 1230. The ingredients 140 can be prepackaged inside the blending sleeve 1220, or added into the blending sleeve 1220 by a user, or both. The container attachment 420 acts on the ingredients 140 inside the blending sleeve 1220.

In one or more embodiments, the blending sleeve 1220 includes a pressure release valve 1230 for preventing excessive pressure buildup inside the blending sleeve 1220 when hot liquid is injected into the blending sleeve 1220 via the injection port 450 of the container attachment 420 and the ingredients 140 are processed inside the blending sleeve 1220.

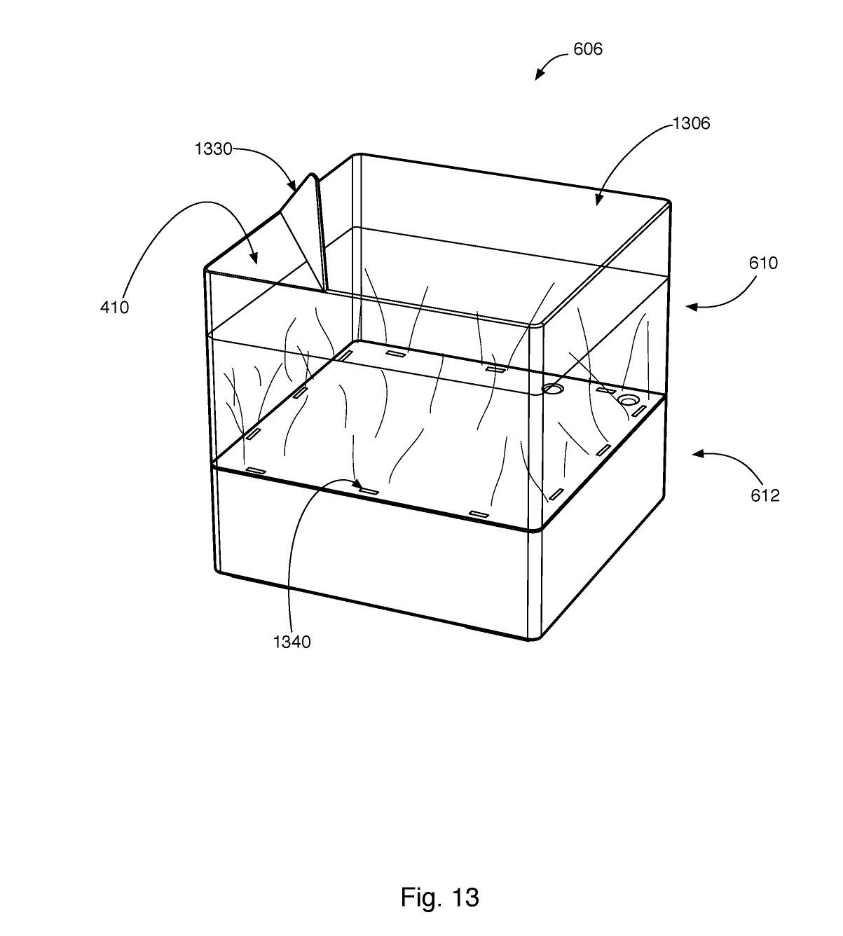

FIG. 13 shows an embodiment of the module 606 in which the upper portion 610 holding the reservoir 410 is formed of a clear plastic material. A set of light emitting devices, e.g., a light emitting device 1340, are disposed around a periphery of the bottom of the reservoir 410. The light emitting devices create a decorative luminous shimmering effect through the liquid in the reservoir 410.

In one or more embodiments, a structure 1330 is formed in a corner of a top surface 1306 of the upper portion 610. The structure 1330 facilitates replenishing of the reservoir 410. A user can carry the module 606 to a liquid source, e.g., a water faucet, a water dispenser of a refrigerator, etc., or use a pitcher or other container of liquid, and structure the 1330 can be opened/closed to facilitate replenishing of the reservoir 410.

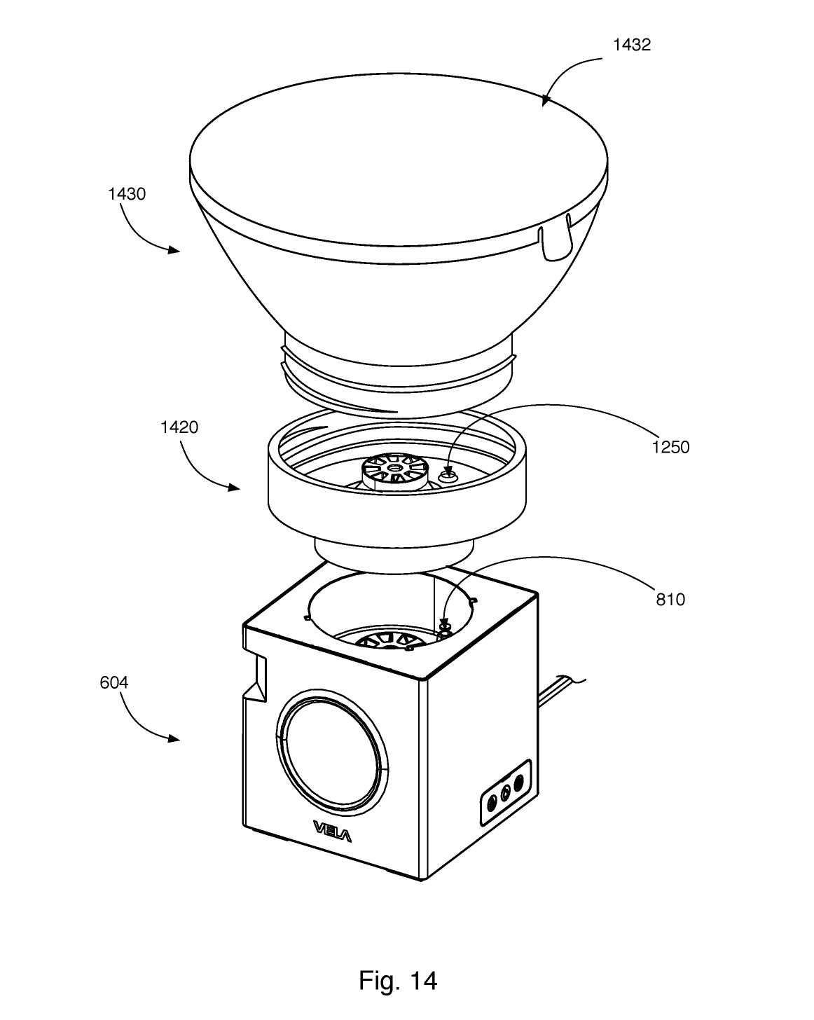

FIG. 14 shows an embodiment of the food processing machine 100 that includes a stirring bowl 1430. The stirring bowl 1430 can contain a set of ingredients enclosed under a removable lid 1432.

The stirring bowl 1430 connects to the drive mechanism 584 via a stirring attachment 1420. The opening 810 of the conduit 812 carries liquid from the reservoirs 410-412 to an injection port 1250 of the stirring attachment 1420 and injects liquid into the stirring bowl 1430.

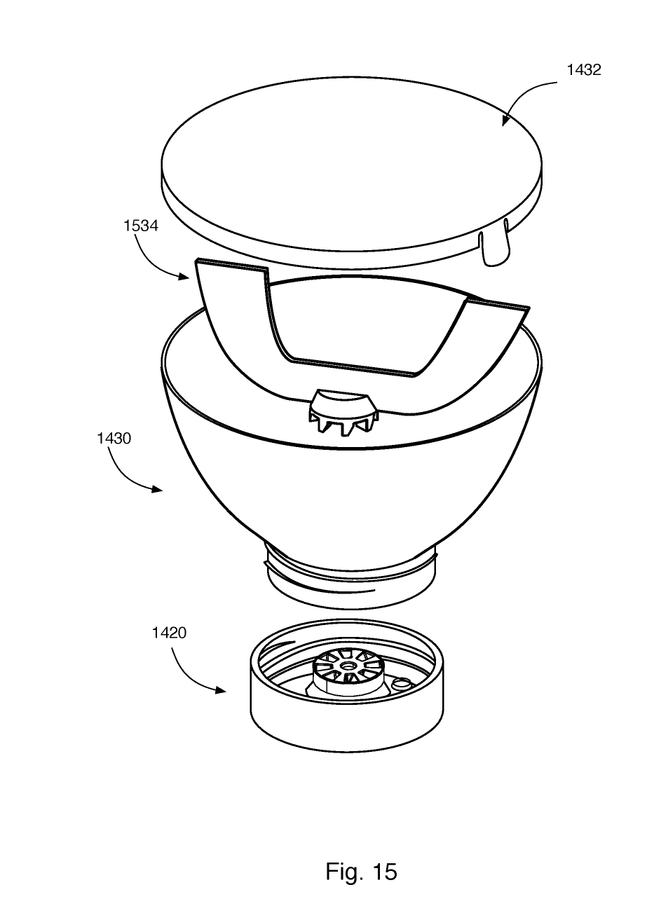

FIG. 15 shows a stirring mechanism 1534 for stirring the ingredients in the stirring bowl 1430 in one or more embodiments. The stirring mechanism 1534 is operatively coupled to the stirring attachment 1420 to stir the ingredients in the stirring bowl 1430 using the drive mechanism 584.

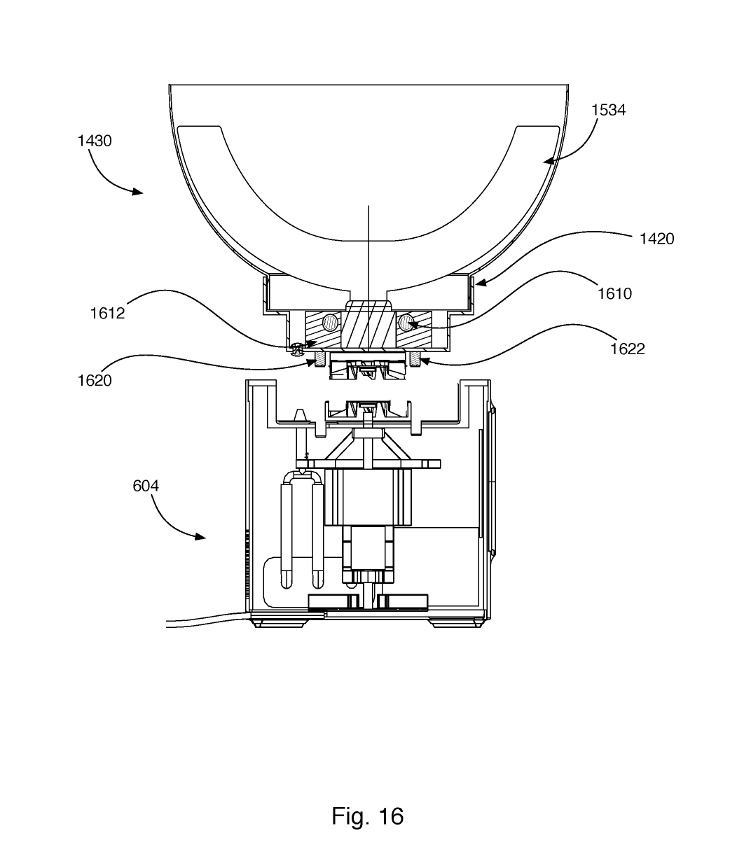

FIG. 16 shows a heating element 1610 in one or more embodiments of the stirring attachment 1420. The heating element 1610 can heat the ingredients in the stirring bowl 1430 while stirring. In one or more embodiments, the heating element 1610 is embedded inside a heat spreading structure 1612. The heating element 1610 can be activated via a pair of electrodes 1620-1622.

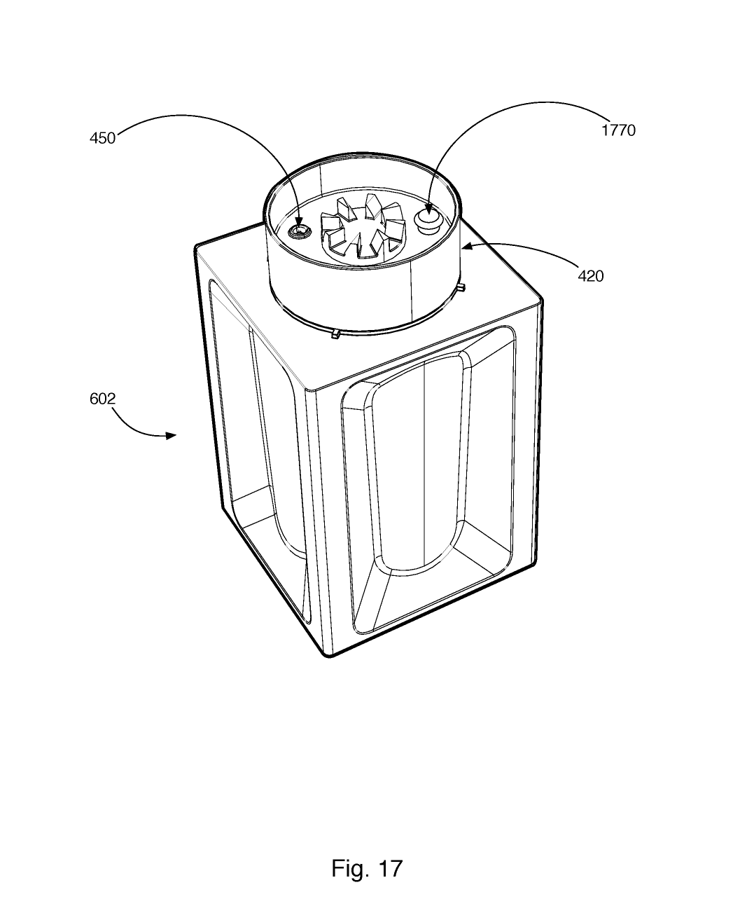

FIG. 17 shows a release button 1770 of the container attachment 420 in one or more embodiments. The release button 1770 when pressed by a user releases pressure from inside the container 130 and releases the container attachment 420 from the container 130.

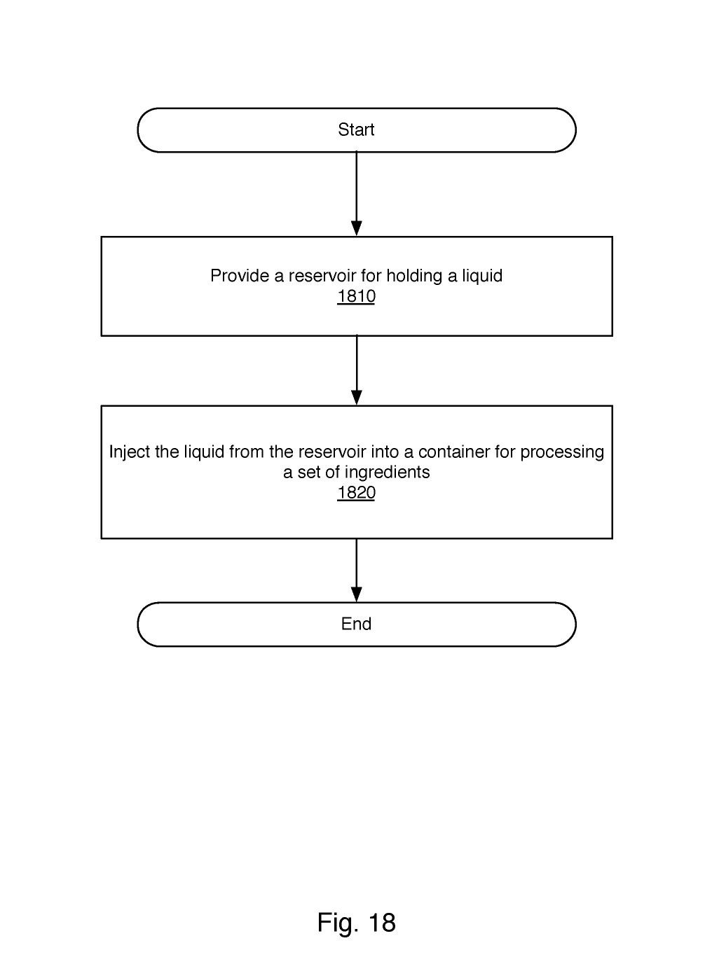

FIG. 18 illustrates a method for food processing in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 16 should not be construed as limiting the scope of the invention.

At step 1810, a reservoir for holding a liquid is provided. The reservoir can hold a liquid at an ambient temperature. The reservoir can hold a hot liquid. At step 1820, the liquid from the reservoir is injected into a container for processing a set of ingredients. The ingredients can be prepackaged in the container or added by a user.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A food processing machine, comprising:
a reservoir for holding a liquid; and
an injection mechanism for conveying the liquid from the reservoir into a container for processing a set of ingredients.

2. The food processing machine of claim 1, further comprising an injection port that enables the liquid to enter the container.

3. The food processing machine of claim 1, further comprising a heating element for heating the liquid.

4. The food processing machine of claim 1, wherein the reservoir includes a liquid of ambient temperature.

5. The food processing machine of claim 1, wherein the reservoir includes a heated liquid.

6. The food processing machine of claim 1, wherein the reservoir includes a liquid of ambient temperature and a heated liquid.

7. The food processing machine of claim 6, wherein the injection mechanism includes a pump for the liquid of ambient temperature and a pump for the heated liquid.

8. The food processing machine of claim 6, further comprising a container attachment that couples to the container and that includes an injection port that enables the liquid of ambient temperature and the heated liquid to enter into the container.

9. The food processing machine of claim 1, further comprising a pressure release mechanism for preventing high pressure buildup inside the container.

10. The food processing machine of claim 1, wherein the reservoir includes a mechanism for facilitating replenishment of the liquid.

11. A method for food processing, comprising:
providing a reservoir for holding a liquid; and
injecting the liquid from the reservoir into a container for processing a set of ingredients.

12. The method of claim 11, wherein injecting comprises injecting the liquid through an injection port of a container attachment to the container.

13. The method of claim 11, further comprising heating the liquid.

14. The method of claim 11, wherein providing a reservoir comprises providing a reservoir for holding a liquid of ambient temperature.

15. The method of claim 11, wherein providing a reservoir comprises providing a reservoir for holding a heated liquid.

16. The method of claim 11, wherein providing a reservoir comprises providing a reservoir for holding a liquid of ambient temperature and providing a reservoir for holding a heated liquid.

17. The method of claim 16, wherein injecting comprises injecting the liquid of ambient temperature and injecting the heated liquid.

18. The method of claim 16, wherein injecting the liquid of ambient temperature and injecting the heated liquid comprises injecting the liquid of ambient temperature and injecting the heated liquid through an injection port of a container attachment to the container.

19. The method of claim 11, further comprising providing a mechanism for releasing a high pressure buildup inside the container.

20. The method of claim 11, further comprising providing a mechanism for facilitating replenishment of the liquid.
